(19) United States
(12) Patent Application Publication
(10) Pub. No.: US 2011/0301751 A1
(43) Pub. Date: Dec. 8, 2011

(54) Low noise humanoid robotic head system

(75) Inventors: Bingtuan Gao, East Lansing, MI (US); Jianguo Zhao, East Lansing, MI (US)

(73) Assignee: Li Creative Technologies, Florham Park, NJ (US)

(21) Appl. No.: 12/801,316

(22) Filed: Jun. 3, 2010

(51) Int. Cl. G06F 19/00

(52) U.S. Cl. 700/245

(57) ABSTRACT

A low-noise humanoid robotic head system, which can effectively mimic motion of human head, is presented in this invention. The system is a four-degrees-of-freedom (DOF) head that has a 3DOF neck and 1DOF lip. Because the involved mechanical components are limited to cables, cable housings, shaft, fixed pulleys, ball bearing, compression springs, rods, and static base plate, the measured a-weighted noise level of the robotic head system is no more than 30 dB.

### FIELD OF THE INVENTION

This invention describes a low-noise humanoid robotic head system that can be utilized in various applications such as speech intelligibility assessment. It has 4DOF motions that include buckling of the head forward and backward, buckling and rotating the head left and right, and vertical lip motion. The first 3DOF movements can be called as pitch, roll, and yaw, respectively. The involved mechanical components of the head are pulleys, cables, compression springs, shaft, and static plates. Because there are no sound generation component's such as gear and electro-driven parts embedded into the invention, there is little noise generated by the robotic head system during its operations.

### BACKGROUND OF THE INVENTION

Many humanoid robotic heads and necks have been developed throughout the world, however it is still a challenge to build a robotic neck that simulates human-like neck motion with very low-noise or without noise. Robotic necks can be classified into four categories according to different developing mechanisms: serial neck, parallel neck, spring-based neck, and spherical neck. Serial neck is very common due to its simple structure and easy DC motor control.

Parallel neck needs a passive spin and is controlled by several legs of combination of universal, prismatic, and spherical joints. The actuators for the parallel necks can be DC motors or pneumatic cylinders. Parallel neck has the characteristics of good rigidity, high load capacity, and high precision, but it is hard and expensive to reach large motion range in the limited neck space. The motion of the spherical neck is based on a spherical joint. Spring neck uses a spring as the spine to support the head and facilitate its motion. Spring neck can usually be driven by motors and artificial muscles. Spring neck is similar to the real human neck and can be built in an economical way.

People need to wear donning respirators or chemical-resistant jackets in some emergency situations, or to execute some special tasks. Most of the current donning respirators or chemical-resistant jackets generate acoustic noises unavoidably when users move their necks. These generated noises influence users' hearing even when users wear wireless communication equipment. The influence can hinder the communication significantly and it can even cause death if users mishear commands in executing some dangerous tasks. Thus, it becomes necessary and important to investigate the acoustic issues associated with the above mentioned situations. A robotic head or neck with low-noise is needed to do the investigation.

Under these requirements, a low-noise humanoid robotic head system with spring neck has been developed in this invention.

### BRIEF SUMMARY OF THE INVENTION

The objective of the invention is to develop a low motion noise or noiseless humanoid head system based on spring neck structures to simulate the human head movement. The head system can generate 1DOF lip movement and 3DOF neck movement. The size of the developed head is similar with the size of an average adult's head. The robotic head can mimic the human head in both motion and the biological performance with low motion noise. As described before, the robotic head is to be applied for investigating the level of acoustic noises generated by the interactive motion between wearable equipments and the human head.

The core components of the robotic head system are a neck and a movable lip. The neck includes two assemblies: one assembly for 2DOF pitch and roll motions and the other assembly for 1DOF yaw motion. The assembly for pitch and roll motions includes a compressed column spring that has the similar function of the human back-bone and that supports the artificial robotic head with the compression force of the spring. The spring can also buckle around the neutral axis to generate 2DOF rotation including pitch and roll motions. The assembly for yaw motion includes a shaft that can rotate along a fixed ball bearing. The 3DOF motion of the neck is driven by six cables that have similar functions of human neck muscles. Specifically, two cables for pitch, two cables for roll, and two cables for yaw motions. These cables are pulled by six motors sealed in a sound insulation box.

The lips have a fixed top lip and a movable bottom lip. The front of the movable bottom lip is supported by two compression springs, and the back of the moveable bottom lip is linked with the fixed top lip by two pivots. The lip motion is achieved by pulling a cable connected with one motor sealed in the sound insulation box as well. All seven cables are covered by cable housings and the cable housings are used to shield the noise for the cables, and then guide the cables to the sound insulation box.

### BRIEF DESCRIPTION OF THE DRAWINGS

FIG. 1 is the layout of the low motion-noise humanoid head system.

FIG. 2 is the motion principle and structure of the lips.

FIG. 3 (a) is the structures of the neck for pitch and roll motions, and FIG. 3(b) is the pitch and roll motion principle of the neck.

FIG. 4 is the side view of the neck to achieve the yaw motion.

FIG. 5 is the designed structure of the robotic head including neck and lips.

FIG. 6 is the side view of the sound insulation box.

### DESCRIPTION OF THE INVENTION

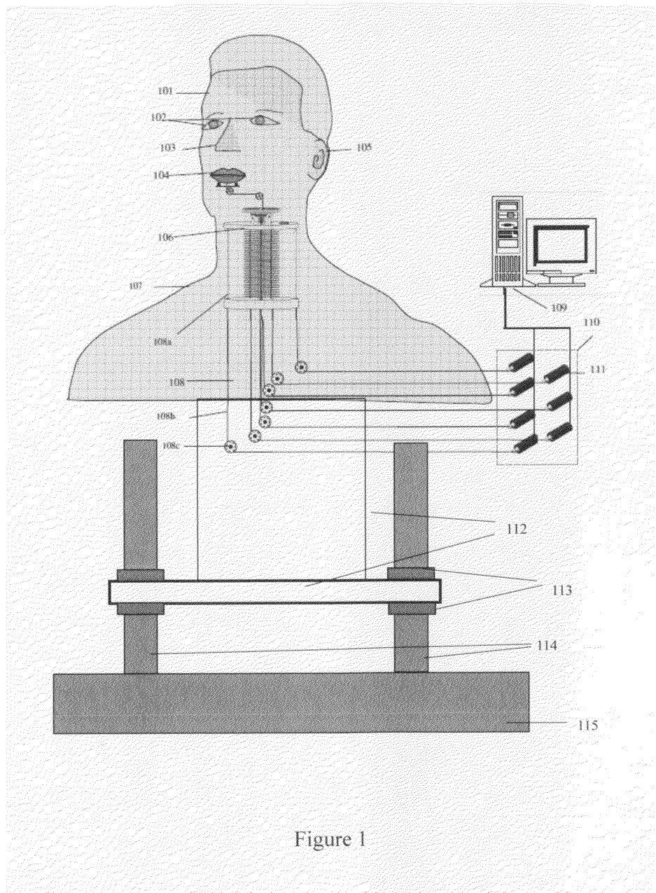

The robotic head system, as shown in FIG. 1 is comprised of a biomimetic skull 101, two eyes 102, a nose 103, 1DOF lips section 104, two artificial ears 105, a 3DOF biomimetic neck 106, a biomimetic chest body 107, a cable-pulley group 108, a PC 109, a sound insulation box 110, seven motors and controllers 111, a PCI-based motion controller board (not shown) inserted into the PCI slot of the PC 109, a head supporting adaptor 112, eight nuts 113, four equally spaced rods 114 around a circle with male threads, and a solid base plate 115. The PC 109, the sound insulation box 110, the seven motors and their controllers 111, and dedicated graphical user interface (GUI) based software for necessary motion control form a closed-loop control system.

For the purpose of the speech recognition assessment, the robot head has the features such as a loudspeaker inside the lip section 104 and minimal hollow cavities inside the head to minimize the noise. The robot skull 101 can be fitted with safety equipment such as gas masks, air-purifying respirators and helmets, as well as safety equipment such as gas masks and air-purifying respirators. The check body 107 can be fitted with various clothes for testing purposes. The size of the robotic head size is similar to the head side of an average adult. The robot head is finally mounted with the solid base 115 through four rods 114 to form a robot that has a size similar to an average adult. The height of the robot can be adjustable by rotating the nuts 113. A level sensor and an inclinometer can be used to monitor and calibrate the orientation of the head system during and after the adjustment. In the application of the speech recognition assessment, two robotic head systems are used and separated with a certain distance. Ears 105 of one robotic head system receive generation sound signals from the loudspeaker located inside the lip section 104 of the other head system.

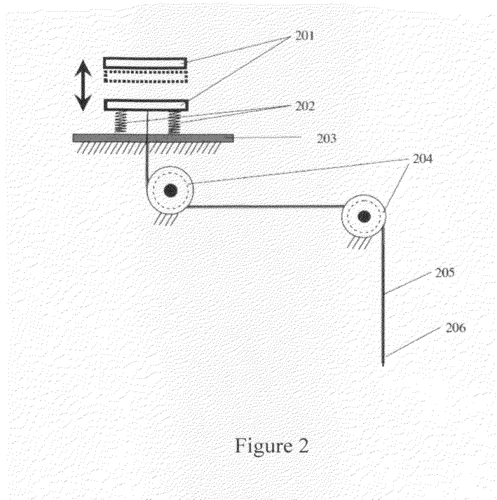

The core parts in the invented robotic head system are lip section 104 and neck section 106, which are described in the following Figures. FIG. 2 shows the motion principle and structure of the lips section 104, as shown in FIG. 1. The lips form 1DOF motion structure which includes a fixed top lip and a moveable bottom lip 201, as shown in FIG. 2. The bottom lip is driven to move up and down to mimic the speaking motion of lips by a cable 205. Two support springs 202 are the motion constraint. When no driven force is applied to the cable 205, the spring force pushes the bottom lip to close with the top lip. Once the cable is driven, the driven force will overcome the spring force to move the bottom lip down. The back of bottom lip is linked with the fixed top lip by two pivots (not shown) and the front of the bottom lip is resting on the springs 202. Two pivots are near two ears of the head system. Two fixed pulleys 204 are used to guide and constrain the cable to the center of the neck and also reduce the friction and motion noises during the lips' movement because of low friction coefficient between cables and pulley. A cable housing 206 is used to shield the noise for the cable 205 and guide the cable as well. In this invention the inner diameter of the cable housing is slightly larger than the outside diameter of the cable.

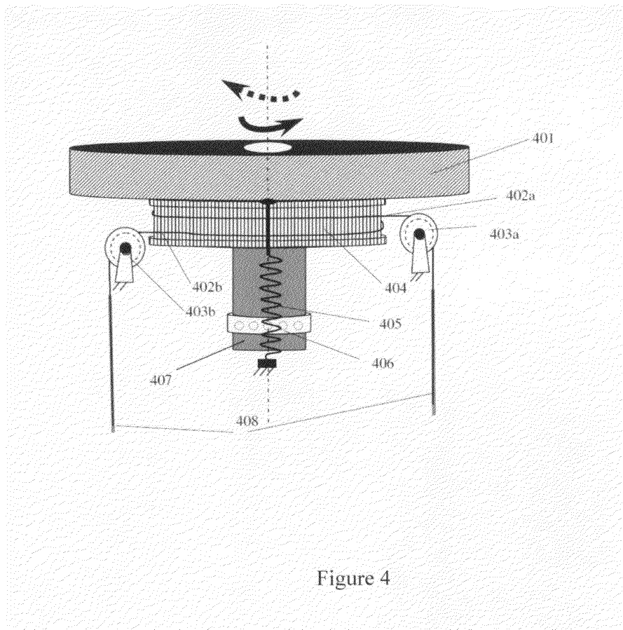

The cable housing 206 has two ends. As shown in FIG. 2, the first end of the cable housing is mounted with a solid base 203 by a mechanical means. The mechanical means consist of adding an adapter between the cable end and the solid base 203 or the cable end can be glued with the solid base 203 directly. The other end of the cable housing is located inside of the insulation box. Another adapter can be used to connect the cable housing end with the parts to mount the motors and controllers or glue can be used for the same purpose. The way to mount all the other cable housing ends can be the same as described here. This solid base 203 rigidly connects with the top fixed lip 201 and a head mounting piece 401 in FIG. 4. The cable can be pulled and released inside the cable housing to introduce relative lip up-and-down movements.

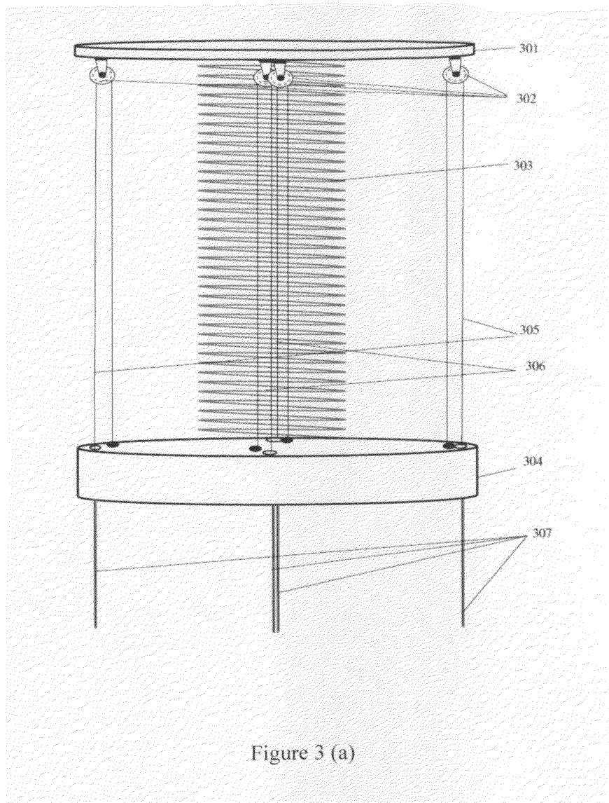

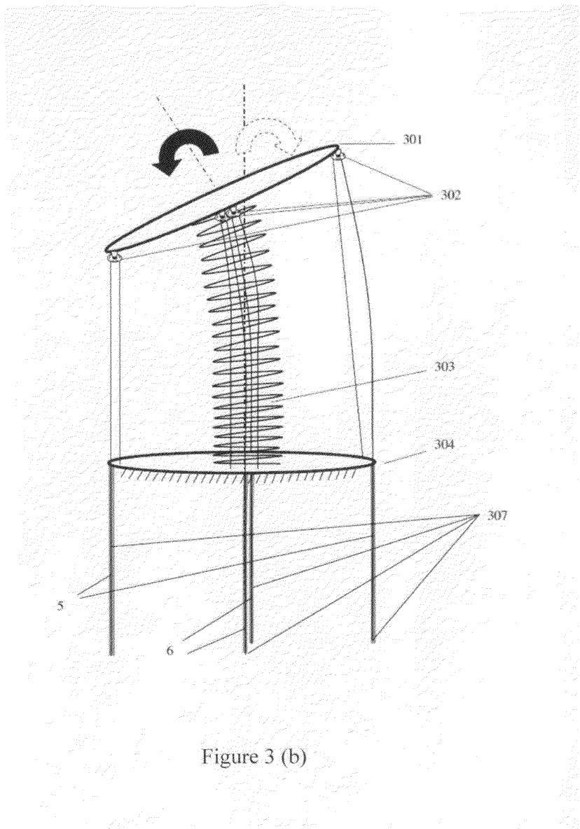

FIG. 3(a) shows the structure of the neck to generate 2-DOF rotation including pitch and roll motion. FIG. 3(b) illustrates the motion principle of the structure. In the structure, a compression spring or spring-like device 303 (e.g. a hydraulic bellow) has the similar function of human cervical vertebrae. When a hydraulic bellow is used, a new control mechanism will be used, but the bellow still works like human cervical vertebrae as the spring in this invention. The spring supports a movable top plate 301 with the compression force from compressed spring 303. The spring itself can be bent along its neutral axis once the force is applied to the cables by the remote controlled motors. If there is no driven force, the spring will maintain the neck in the initial position. The spring is stiff enough to hold the said movable top plate for in-position stability and soft enough to make pitch and roll movements when the force is applied through the said cables and said cable housings. Top end of the spring 303 is glued with bottom side of the movable top plate 301 in the bottom surface of the top plate, and bottom end of the spring 303 is glued with top side of a fixed bottom plate 304.

Four symmetrically assembled cables 305 and 306 work like human muscles. As shown in FIG. 3(a) and (b), when the force applies to the cables 305 the pitch motion of the structure will generate. Similarly, the force applied to the cables 306 will form the roll motion. Four symmetrically assembled cables are the basic configuration. Fine pitch and/or roll motions can be achieved when more cables are assembled to drive the top plate 301. More cables are equivalent to adding more muscles. The bottom plate 304 is used to form the frame of the head and avoid the neck deformation. To avoid mechanical motion noises between the cables and guiding holes in the plates, four cable housings 307 are employed in the structure. The cable housing has the same functions as described in the above paragraph and it has two ends. Four ends of four cable housing are mounted with the bottom surface of the fixed bottom plate mechanically or glued with the fixed bottom plate. The other four ends of four cable housings are sealed in the insulation box. The force of every cable pulling the top plate can be two times the force from the driving motors due to fixed pulleys 302. This way the invention can lower the requirements for the motors.

FIG. 4 describes the structure for yaw motion of the neck section. The structure is mounted on the top plate 301 of the neck structure as shown in FIGS. 3(a) and 3(b). In FIG. 4 cables 402a and 402b, together with a rotating pulley 404, are employed to generate the yaw motion. One end of each cable of cables 402a and 402b is fixed with the rotating pulley 404 by a mechanical means. The mechanical means can consist of drilling a hole in the pulley and inserting a pin, so one end of the cable can be tightened with the pin. The other ends of cables 402a and 402b are driven by the motors sealed in the insulation box. Two fixed pulleys 403a and 403b are used to guide the driven cables as well as to reduce the motion noises. A shaft 407 and the head mounting piece 401 that is mentioned in FIG. 2 are both connected with the rotating pulley 404 with threads. The head mounting piece 401 works as an adaptor between the rotating pulley 404 and robotic lip section in FIG. 2. The lip section in FIG. 2 rests on top of the heading mounting piece 401. Ball bearing 406 is mounted on top of the movable top plate 301 in FIG. 3(a) and (b). A constraint spring 405 can maintain the heading mounting piece for the yaw motion in the initial nominal position when no driven force is applied to the structure through the cables. Two cable housings 408 are applied after the cables pass through the pulleys 403a and 403b. These two cable housings 408 are fastened in the movable top plate 301 in FIGS. 3(a) and 3(b). The function of cable housings is the same as described before. Two ends of these two cable housings are fixed with movable top plate 301 in FIG. 3(a) and (b), and the other two ends of two cable housings are sealed in the insulation box.

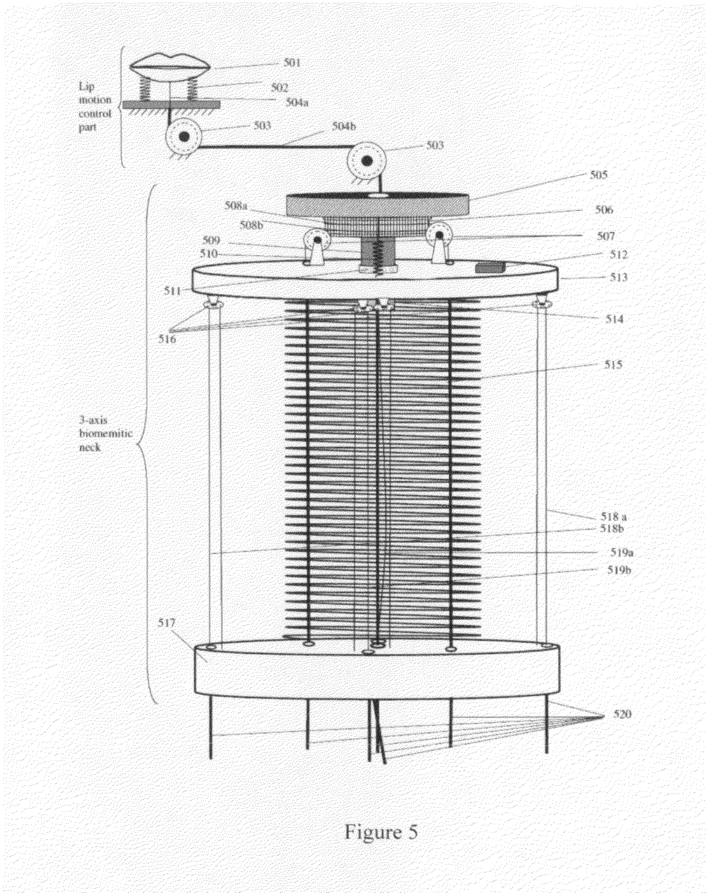

In FIG. 5 1DOF of lip motion and 3DOF of neck motion are combined together. The cables and cable housings 504a, 504b, 508a and 508b as shown in FIG. 5, pass through the neck section and are connected with motors. This way the lips 501 and humanoid neck are integrated as one whole robotic head. Sensors 512 and 514 for monitoring the motion of the 3DOF neck are mounted as shown in FIG. 5. Sensor 512 is a two-axis inclinometer to measure the angles of pitch and roll rotations. Sensor 512 is mounted on the top surface of the top plate 513. The measuring axes of the sensing elements are parallel to the mounting plane and orthogonal to each other. A preferred inclinometer needs to be high resolution, low-noise, and insensitive to vibration. Sensor 514 is a potentiometer to measure the angle of yaw movement and is used to monitor rotating angles of the inserted shaft 509. Sensor 514 has a housing mounted with the top movable plate 513. A preferred potentiometer can be a hollow-shaft conductive plastic potentiometer. The measured angle signals from sensor 512 and sensor 514 are utilized by the closed-loop control system for accurate remote motion control. The fixed top lip 501, and two fixed support springs 502, and fixed pulleys 503 are all rigidly connected with the heading mounting piece 505 so that the lip structure has movement relative to pitch, roll and yaw motion. Thus, the lip motion can combine efficiently with pitch, roll and yaw motion together to form a 4DOF head system. Head mounting piece 505, yaw rotating pulley 506, and shaft 509 are connected with threads. Ball bearing 11 is rigidly mounted with the top plate 513. Cable and cable housing 504 connect with one motor to achieve lip motion in vertical direction. Every cable and cable housing of 508a, 508b, 518a, 518b, 519a, and 519b connect with a separate motor. The total number of motors is seven as shown in FIG. 1. Pitch, roll and yaw motions can be controlled separately or simultaneously by seven motors. For example, the robotic head can have lip motion and yaw motion simultaneously or separately.

In the head system as shown in FIG. 1, the cable-pulley group 108 is used to connect the cables of lip and neck of the robotic head with the motors. In FIG. 1, the cable-pulley group includes seven cables 108a, seven cable housings 108b, and seven fixed pulleys 108c. A cable, a cable housing, and a pulley form one sub-group. There are seven sub-groups for the head system. Specifically, two sub-groups are for yaw motion, two for pitch, two for roll movement, and one for lip motion. The materials of the driving cables 108a can be polyester. A preferred cable can be braided with extra-strength polyester twine and off-the-shelf parts. Cable housings 108b are used to guide the driving cables or transmit the outputs of motors from the sound insulation box to the robot head to shield the noise. The advantages of using the cable housing include, but are not limited to, simplifying the mechanical transmission design significantly (few noises generated by the cable-and-housing group) and facilitating the sealing issue for the sound insulation box. The cable housings can be bicycle brake cable housings, and can be easily found on the market. Because there is one layer of lubricated inner cable housing, the friction coefficient is relatively low between the cable and its housing. The cable housing can maintain low-friction and low-noise transmission for the head system. These pulleys 108c are used to constrain the cable housings 108b.

The closed-loop control system, as described in FIG. 1, includes the sound insulation box, seven motors and their corresponding controllers, the PC, the PCI-based motion controller board, and GUI based software. The noisy cable-pulling motors are all sealed in the sound insulation box. There are two natural ways to remove the noises passively. One is sound insulation and the other is sound absorption. Sound insulation consists of eliminating the sound path from the sound source. Usually the high density materials are good materials for sound insulation. Sound absorption starts when some or all of the incident sound energy are either converted into heat or pass through the absorbers like porous foams. To prevent sound transmission from the box, sound insulation and sound absorption techniques are both applied in the invention.

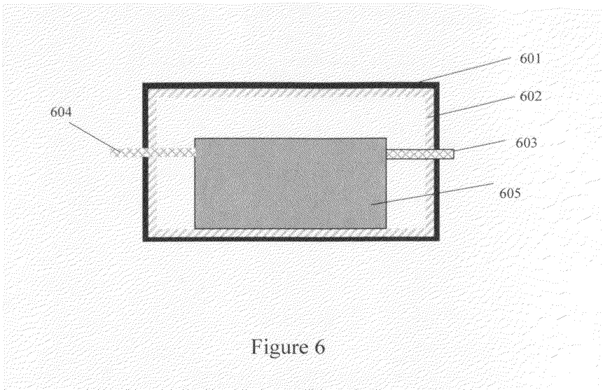

FIG. 6 shows the side view of the sound insulation box. The box 601 includes the door and walls and is made of heavy material; 14-gauge cold-rolled steel with sound leak proof method for the sound insulation. The six inner walls of the box were covered by 10 mm thick butyl rubber 602 that has good acoustic absorption effects. The rubber helps to absorb the noises with frequencies ranging from 30 Hz to 4000 Hz. The size of the sound insulation box is big enough to install seven motors and their controllers. One end of the cable-and-housing group 603 is located inside the sound insulation box and fixed with the assembly of seven sets of motors and controllers 605 and power and control signal cables 604 are connected with the PC. The outside dimensions of the sound insulation box can be 62 cm in length, 46 cm in width, and 57 cm in height.

In brief, 4DOF movements are driven by the motors installed in the sound insulation box through the compound cable-pulley groups. The motors are controlled by the PC via the PCI-based motion controller board. The graphical user interface (GUI) based software can remotely control 1DOF lip motion and 3DOF of pitch, roll and yaw motions separately or simultaneously.

Detailed preferred embodiments of the robotic head are for the robotic neck. The robotic head can bend to either the left or right direction 30 degrees with a preferred velocity of 100 degrees per second. The robotic head can have flexion and extension of 30 and 45 degrees, respectively, with a preferred velocity of 100 degrees per second. The head can rotate to the left and right direction from a nominal position for 60 degrees with a preferred velocity of 120 degrees per second. The developed robotic neck has a positioning accuracy of less than 1 degree during neck motion. For the lip section, bottom lip can move down for 20 mm with a repetition rate of 2 Hz. Measured maximum weighted noise level is no more than 30 dB without personal protective equipment (PPE or PPEs). For motion parameters of the robot head with different PPE or combined PPEs, the motion ranges/velocities could be decreased based on different PPE or PPEs.

1. A low-noise humanoid robotic head system comprising of a biomimetic skull, two eyes, a nose, 1DOF lips section, a left and a right artificial ear assembly, a 3DOF biomimetic neck, a biomimetic chest body, a cable-pulley group, a closed-loop control system, and a supporting assembly.

2. The said 1DOF lips section in claim 1 is comprised of a fixed top lip, a movable bottom lip, two supporting compression springs, a cable, a cable housing, two fixed pulleys, and one fixed base.

3. The said 3DOF neck in claim 1 is comprised of one assembly for 1DOF yaw motion and another assembly for 2DOF pitch and roll rotations.

4. The said cable-pulley group in claim 1 is comprised of seven cables, seven cable housings, and seven fixed pulleys.

5. The said closed-loop control system in claim 1 is comprised of seven step motors and their controllers, one sound insulation box, a PC, a PCI-based motion controller board, and a corresponding graphical user interface (GUI) based software for required motion controls.
a) The said insulation box contains the seven step motors and controllers are installed inside the said sound insulation box to minimize generated noises from the said motors and controllers.
b) The said motors are comprised of their controllers, PC, PCI-based board, and GUI based software. The said motors are controlled by the said PC via the said PCI-based motion controller board and the GUI based software can remotely control 1DOF lip motion and 3DOF neck movements separately or simultaneously. The GUI based software can also be developed by any computer language for GUI application.

6. The said supporting assembly is comprised of a supporting adaptor, four rods with a set of square holes, four square pins, and a solid base. The said supporting adaptor can be adjusted by positioning the said four pins to different heights and mechanically tightening the rods with screws. The four rods are rigidly connected with the said solid base.

7. The said 1DOF lips in claim 2 have a moveable bottom lip that rests on two said supporting compression springs. The said movable bottom lip is linked with the fixed top lip by two pivots and the motion of the bottom lip is driven by the said cable. One end of cable housing is fixed with the bottom side of the said fixed base and the other end is sealed inside the said insulation box as in claim 5.

8. The said assembly for 1DOF yaw motion in claim 3 is comprised of a head mounting piece, a shaft, a rotating pulley, two fixed pulleys, a ball bearing, a potentiometer, two cables, and two cable housings.
a) The said potentiometer contains measured angle signals of yaw motion that provide position feedback for the said closed-loop control system as in claims 1 and 5. The said potentiometer is mounted with the said movable plate and the said shaft can rotate inside of the said potentiometer.
b) The said head mounting piece, shaft, and rotating pulley are connected with threads.
c) The said heading mounting piece fixes the said lips section in claims 1, 2 and 7.

9. The said assembly for 2DOF pitch and roll rotations as in claim 3 is comprised of a movable top plate, a fixed bottom plate, a compressed column spring, four cables, four fixed pulleys, four cable housings, and an inclinometer.
a) The said column spring contains two ends which are constrained with a said movable top plate and a said fixed bottom plate.
b) The inclinometer has measured angle signals of pitch and roll rotation that are utilized as position feedbacks for the closed-loop control system in claims 1 and 5 and the inclinometer is mounted on top of the moveable top plate.
c) The four pulleys are used to double the force provided by the motors in claims for pitch and roll motion controls.
d) The movable top plate fixes four fixed pulleys, two ends of two cables housings in claim 8, the said ball bearing, and the said potentiometer in claim 8.
e) The said fixed bottom plate fixes four ends of the said four cable housings and fixes four ends of the said cables.

10. The cable-pulley group in claims 1 and 4 integrate the said lips, the said neck, and the said closed-loop control system into the said robotic head system as in claim 1.

11. The said cable, cables, cable housing, and housings in claims 2, 4, 8 and 9, are used to shield the noises of the said cable and cables, and guide the said cable and cables as well.

12. The said fixed pulley and pulleys in claims 2, 4, 8 and 9 are used to guide and constrain the said cable, cables, cable housing, and cable housings in claims 2, 4, 8 and 9.

13. The said cable, cables, cable housing, and housings in claims 2, 4, 8 and 9 and the other end of the said cable housing in claim 2 is sealed in the said sound insulation box as in claim 5. The other ends of the said cable housings as in claims 2, 8, and 9 are sealed in the sound insulation box as in claim 5.

14. The said cable and cables in claims 2, 4, 8, and 9 are driven by the said motors in claim 5.
